(19) United States
(12) Patent Application Publication
(10) Pub. No.: US 2024/0400425 A1
(43) Pub. Date: Dec. 5, 2024

(54) METHOD AND APPARATUS FOR TREATMENT OF A POOL SYSTEM

(71) Applicant: Hydrologic Systems LLC, Rochester, NY (US)

(72) Inventors: Michael Kaminski, Rochester, NY (US); Michael Gonek, West Hollywood, CA (US)

(21) Appl. No.: 18/679,873

(22) Filed: May 31, 2024

Related U.S. Application Data
(60) Provisional application No. 63/470,331, filed on Jun. 1, 2023.

(51) Int. Cl. C02F 1/68; B01F 23/43; B01F 23/451; B01F 25/312; B01F 33/453; B01F 101/00; C02F 1/00; C02F 103/42; E04H 4/12

(52) U.S. Cl. CPC C02F 1/686; B01F 23/43; B01F 23/451; B01F 25/31243; B01F 33/453; C02F 1/008; E04H 4/1281; B01F 2101/305; C02F 2103/42; C02F 2201/009; C02F 2209/008; C02F 2209/04; C02F 2209/06; C02F 2209/42

(57) ABSTRACT

A pool-side, unplumbed, solar powered treatment system configured to monitor pool water and selectively introduce a plurality of different chemicals through individual pumps and feed lines to a return line to the pool. The present treatment system uses oxidation reduction potential, ORP, as a surrogate for chlorine/bromine/other oxidizer and pH probes to monitor water quality in real time and dispense appropriate amounts of chemicals to maintain a predetermined chemistry in a pool. The system introduces the chemicals into filtered pool water through a venturi or eductor.

### CROSS-REFERENCE TO RELATED APPLICATIONS

This application claims the benefit of U.S. Provisional Application No. 63/470,331, filed Jun. 1, 2023, and entitled METHOD AND APPARATUS FOR TREATMENT OF A POOL SYSTEM, the entirety of which is hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A SEQUENCE LISTING

Not applicable.

### STATEMENT REGARDING PRIOR DISCLOSURES BY THE INVENTOR OR A JOINT INVENTOR

Not applicable.

### BACKGROUND OF THE INVENTION

### Field of the Invention

The present disclosure generally relates to an apparatus and method for automatically monitoring and treating pool water in response to onsite testing, wherein the monitoring and treating can be remotely supported and reported.

### Description of Related Art

Pools, spas, water features, and other such bodies of water (hereinafter referred to as “pools”) typically have a circulation system that continually pumps water from the pool through a filter and, optionally, a heater before returning the water back to the pool. The circulation system helps to maintain sanitary conditions of the pool water. Typically, the water passes through the filter to reduce the accumulation of foreign material, such as hair, soil, or solids. The water may subsequently pass through the heater, where the water may be heated prior to returning to the pool.

Control of the chemical balance of the pool water may be built into the filtration system which may periodically introduce pre-set amounts of chemical to the pool. However, as the chemical condition of the pool is not continuously monitored, the added chemicals are not in response to actual conditions which can vary dramatically depending on pool usage, weather, temperature, and other environmental factors. Thus, the built in system can cause the chemical balance of the pool to depart from a proper or intended range. Alternatively, sensor actuated systems can be utilized to add chemicals into a pool recirculation system, but existing systems are housed inside the pool equipment room, are permanent and non-portable, and require professional electrical and plumbing installation.

### BRIEF SUMMARY OF THE INVENTION

The present disclosure provides a treatment system that interfaces with an existing pool filtration system, wherein the present treatment system actively monitors the conditions of the pool water and introduces the appropriate chemicals into a return line of the existing pool filtration system.

One aspect of the present disclosure is directed to a water treatment apparatus for a pool system. The pool system includes a pool wall configured to retain pool water therein, a circulating pump having an intake and an outlet, an intake line connecting the pool to the intake, and a return line connecting the outlet to a return jet at the pool. The treatment apparatus comprises a chemical introduction unit; a dispensing unit; a sensor unit; and a controller. The chemical introduction unit has a first end configured to be coupled to the return jet and a second end configured to be in fluid communication with the pool water to selectively dispense a controlled quantity of an additive to the pool water. The dispensing unit comprises a first chemical reservoir connected to the chemical introduction unit through a first line, the first chemical reservoir configured to retain a first chemical therein; and a second chemical reservoir connected to the chemical introduction unit through a second line, the second chemical reservoir configured to retain a second chemical therein. The sensor unit includes a pH sensor configured to be received within the pool to sense a pH value of the pool water; an oxidation-reduction potential (ORP) sensor configured to be received within the pool to sense an ORP of the pool water; and a first communications module configured to be coupled to the pool wall outside of the pool water. The first communications module is communicatively coupled to the pH sensor and the ORP sensor. The controller includes a control unit operably connected to the dispensing unit; and a second communications module communicatively coupled to the first communications module of the sensor unit to receive sensed pH data and sensed ORP data of the pool water. The controller is configured to regulate an amount of the first chemical dispensed from the first chemical reservoir and passing through the chemical introduction unit, wherein the amount of the first chemical dispensed is based at least in part on the sensed pH of the pool water, and an amount of the second chemical dispensed from the second chemical reservoir and passing through the chemical introduction unit, wherein the amount of the second chemical dispensed is based at least in part on the sensed ORP of the pool water.

In another aspect, the dispensing unit may further comprise a first level sensor configured to sense a fluid level of the first chemical in the first chemical reservoir and a second level sensor configured to sense a fluid level of the second chemical in the second chemical reservoir. The first level sensor and the second level sensor are each communicatively coupled to the second communications module. When the sensed fluid level of the first chemical and/or the sensed fluid level of the second chemical is below a respective preselected threshold, the second communications module is configured to automatically order additional at least one of the first chemical and the second chemical based upon which sensed fluid level is below its respective preselected threshold.

In still another aspect, each of the first communications module and the second communications module may be at least one of Wi-Fi enabled, Bluetooth enabled, cellular network enabled, and Long Range (LoRa) enabled. The second communications module may also be configured to receive weather data local to the pool with the pool being one of a swimming pool, a spa pool, a swim spa, a wading pool, and a spray pool.

In yet another aspect, the chemical introduction unit includes a venturi having an inlet configured to be coupled to the return jet to receive pool water from the return line and an outlet configured to be in fluid communication with the pool water within the pool. The venturi further includes a throat located between the inlet and outlet, wherein the throat has a smaller open interior diameter than an open interior diameter of the inlet and an open interior diameter of the outlet. The venturi further includes a port having a first end in fluid communication with the throat and a second end configured to be fluidly coupled to dispensing unit to inject one or both of the first chemical and the second chemical into the pool water. The venturi may be an eductor.

In further aspects, the dispensing unit may include a first flow meter fluidly coupled to the first chemical reservoir and a second flow meter fluidly coupled to the second chemical reservoir; the dispensing unit may also include a first peristaltic pump fluidly coupled to the first chemical reservoir and a second peristaltic pump fluidly coupled to the second chemical reservoir; a photosensor may be coupled to the controller so that the dispensing unit is only turned on during the night; and the treatment apparatus may also include a rechargeable battery, a solar panel, and a charge controller.

In still another aspect, the dispensing unit may further comprise a third chemical reservoir connected to the chemical introduction unit through a third line. The third chemical reservoir may be configured to retain a third chemical therein and the controller is configured to regulate an amount of the third chemical dispensed from the third chemical reservoir and passing through the chemical introduction unit. A third level sensor may also be configured to sense a level of the third chemical in the third chemical reservoir. The third level sensor may be communicatively coupled to the second communications module, wherein when the sensed fluid level of the third chemical is below a preselected threshold, the second communications module is configured to automatically order additional third chemical. The second communications module may also be configured to receive weather data local to the pool and the controller may be configured such that the third chemical is dispensed as a function of one of an elapsed time and received weather data.

In yet another aspect, the dispensing unit further comprises a fourth chemical reservoir connected to the chemical introduction unit through a fourth line, the fourth chemical reservoir configured to retain a fourth chemical therein; and wherein the controller is configured to regulate an amount of the fourth chemical dispensed from the fourth chemical reservoir and passing through the chemical introduction unit. The dispensing unit may further comprise a fourth level sensor configured to sense a fluid level of the fourth chemical in the fourth chemical reservoir. The fourth level sensor may be communicatively coupled to the second communications module, wherein when the sensed fluid level of the fourth chemical is below a preselected threshold, the second communications module is configured to automatically order additional fourth chemical. The second communications module may also be configured to receive weather data local to the pool and the controller is configured such that a predetermined volume of the fourth chemical is introduced as a function of one of at least one of an elapsed time and received weather data. The dispensing unit may also include an agitator coupled to the fourth chemical reservoir wherein the agitator is configured to stir the fourth chemical prior to dispensing the fourth chemical to the chemical introduction unit. The agitator may comprise a magnetic stir plate positioned below the fourth chemical reservoir and a magnetic stir bar contained within the fourth chemical reservoir, wherein powering of the magnetic stir plate causes the magnetic stir bar to spin. The fourth chemical reservoir may also include a magnetic stir bar securement to prevent decoupling of the magnetic stir bar from the magnetic stir plate.

A further aspect of the present disclosure is directed to a method for treating water within a pool system wherein the pool system includes a pool wall configured to retain pool water therein, a circulating pump having an intake and an outlet, an intake line connecting the pool to the intake, and a return line connecting the outlet to a return jet at the pool. The method includes providing a water treatment apparatus having a chemical introduction unit having a first end configured to be coupled to the return jet and a second end configured to be in fluid communication with the pool water, a dispensing unit having a first chemical reservoir connected to the chemical introduction unit through a first line and a second chemical reservoir connected to the chemical introduction unit through a second line, a sensor unit including a pH sensor, an oxidation-reduction potential (ORP) sensor, and a first communications module, and a controller including a control unit and second communications module communicatively coupled to the first communications module of the sensor unit; sensing, via the pH sensor, a pH value of the pool water; sensing, via the ORP sensor, an ORP of the pool water; receiving at the second communications module via the first communications module, the sensed pH data and the sensed ORP data of the pool water; regulating, via the controller, an amount of the first chemical dispensed from the first chemical reservoir and passing through the chemical introduction unit, wherein the amount of the first chemical dispensed is based at least in part on the sensed pH of the pool water; and regulating, via the controller, an amount of the second chemical dispensed from the second chemical reservoir and passing through the chemical introduction unit, wherein the amount of the second chemical dispensed is based at least in part on the sensed ORP of the pool water.

The following will describe embodiments of the present disclosure, but it should be appreciated that the present disclosure is not limited to the described embodiments and various modifications of the invention are possible without departing from the basic principles. The scope of the present disclosure is therefore to be determined solely by the appended claims.

### BRIEF DESCRIPTION OF THE SEVERAL VIEWS OF THE DRAWING(S)

FIG. 1 is a schematic view of a prior art pool and pool filtration system;

FIG. 2 is a schematic top view of an exemplary water treatment apparatus in accordance with the present invention;

FIG. 2A is an expanded view of a venturi device suitable for use within the exemplary water treatment apparatus shown in FIG. 2;

FIG. 3 is a rendering of a layout of an exemplary embodiment of a sensor unit suitable for use within the exemplary water treatment apparatus shown in FIG. 2;

FIG. 4 is a perspective view of an exemplary embodiment of a dispensing unit suitable for use within the exemplary water treatment apparatus shown in FIG. 2;

FIG. 5 is a schematic top view of the exemplary dispensing unit shown in FIG. 4;

FIG. 6 is a schematic cross section view of the exemplary dispensing unit shown in FIG. 4, taken generally along line 6-6 in FIG. 5;

FIG. 7 is a rendering of a layout of an exemplary embodiment of a dispensing unit suitable for use within the exemplary water treatment apparatus shown in FIG. 2;

FIGS. 8A and 8B show a flow chart of an exemplary program logic for operation of an acid system within the exemplary water treatment apparatus shown in FIG. 2;

FIGS. 9A and 9B show a flow chart of an exemplary program logic for operation of an oxidation-reduction potential system within the exemplary water treatment apparatus shown in FIG. 2;

FIG. 10 is a flow chart of an exemplary program logic for operation of a clarifier system within the exemplary water treatment apparatus shown in FIG. 2; and

FIG. 11 is a flow chart of an exemplary program logic for operation of liquid solar blanket system within the exemplary water treatment apparatus shown in FIG. 2.

### DETAILED DESCRIPTION OF THE INVENTION

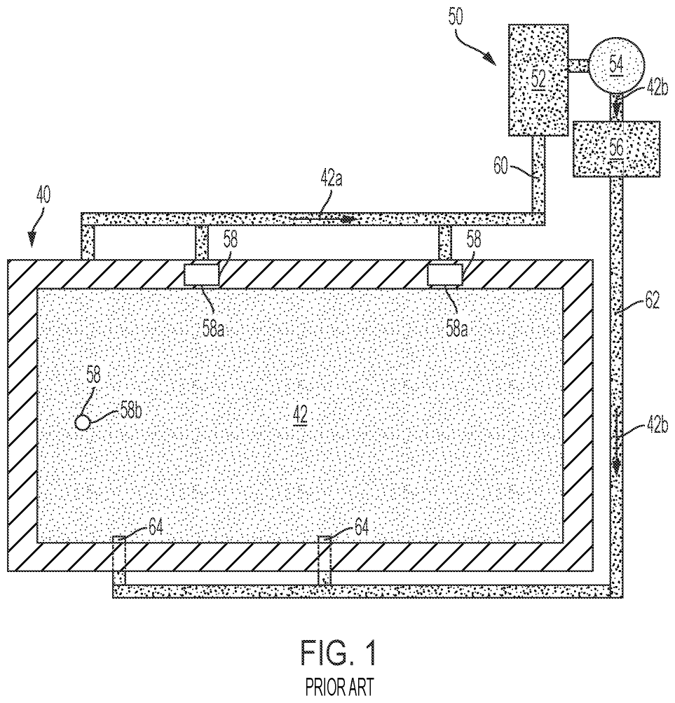

With reference to FIG. 1, an existing prior art pool filtration system 50 for use with a pool 40 typically includes a pump 52 and a filter 54, as well as one or more optional heaters 56, plumbed in series. Pool filtration system 50 may further include a plurality of inputs 58 from pool 40 such as a skimmer 58a and/or a bottom inlet/drain 58b which are fluidly connected to pump 52 via intake line 60. Pump 52 draws pool water 42 from pool 40 and passes the withdrawn water 42a through filter 54. The filtered water 42b then passes to heater 56, if used, and then through a return line 62, such as through one or more return jets 64, to be reintroduced with the pool water 42 in pool 40.

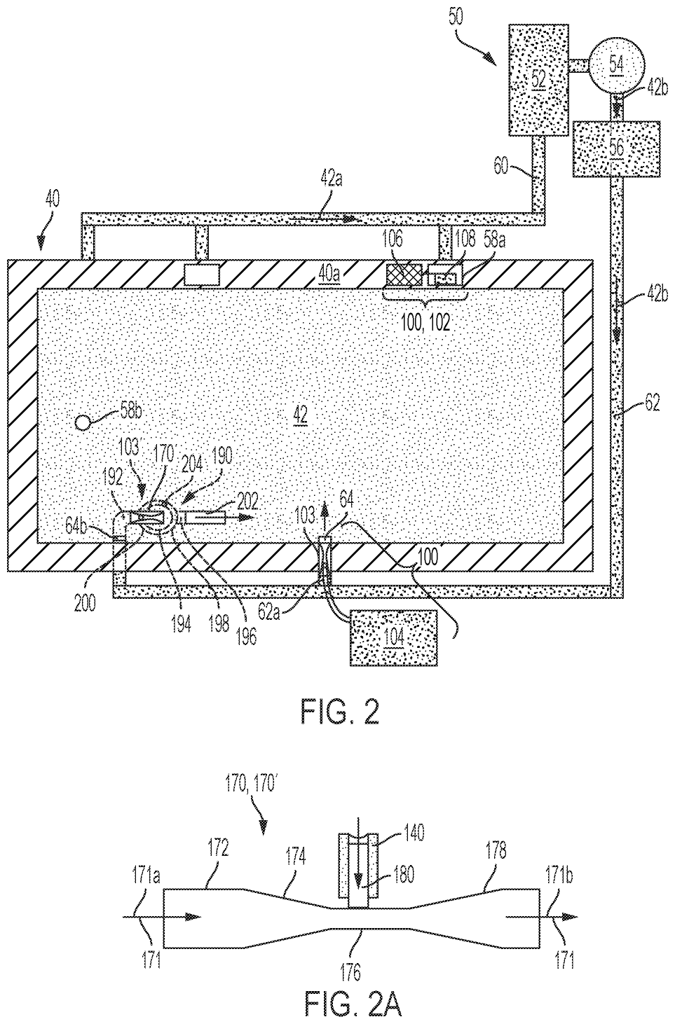

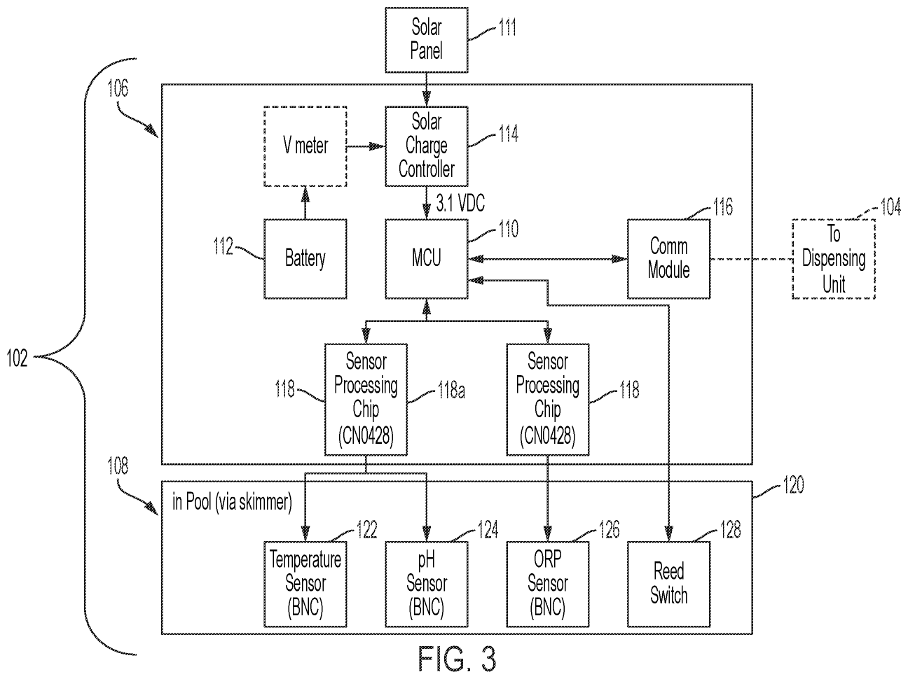

Turning now to FIG. 2, an exemplary embodiment of a water treatment apparatus 100 is shown interfaced with pool filtration system 50 which was described above with regard to FIG. 1. As shown, water treatment apparatus 100 may comprise a sensor unit 102, a chemical introduction unit 103, and a dispenser unit 104; each of which will be discussed in greater detail below. In one nonlimiting aspect of the invention, water treatment apparatus 100 may be fluidly coupled with pool filtration system 50 through an unplumbed connection.

As used herein the term pool is understood to include a swimming pool, a spa pool, a swim spa, a wading pool, a wave pool, a spray pool, or any artificial, man-made body of water. Additionally, the term “unplumbed” is in reference to an exemplary embodiment of the water treatment apparatus that does not require any separate or additional intake lines 60 from pool 40 or return lines 62 to pool 40. Dispenser unit 104 of unplumbed water treatment apparatus 100 may simply tap into a portion 62a of the existing return line 62 in pool filtration system 50 while sensor unit 102 is simply placed in conjunction with the existing skimmer 58a, as will be described in greater detail below. In other words, unplumbed water treatment apparatus 100 may be contemplated as a “plug-and-play” system requiring minimal installation time, equipment, and know-how. Preferably, the portion 62a of return line 62 that is tapped to include water treatment apparatus 100 is downstream of any equipment, such as pump impellers of pump 52 and/or heat exchangers, such as copper heat exchangers, of heater 56; and more preferably is couple at or immediately before return jet 62 within pool wall 40a. Water treatment apparatus 100 may thereby be exposed only to the moving filtered water 42b exiting from pool filtration system 50.

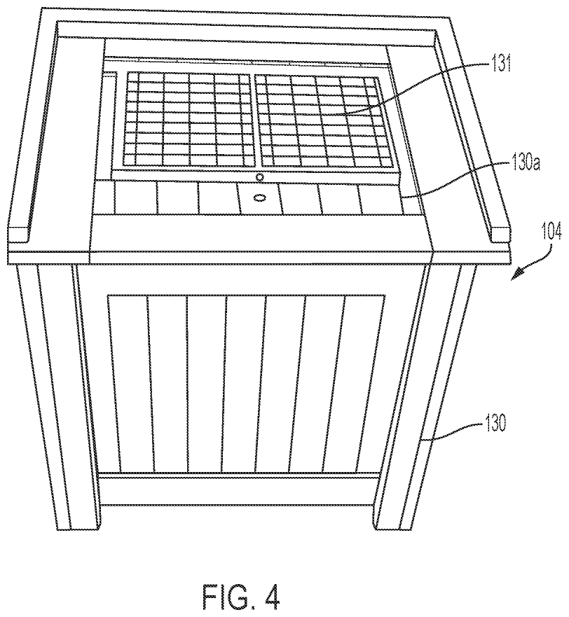

In one aspect of the invention, sensor unit 102 of water treatment apparatus 100 may include a control subunit 106 and a sensor subunit 108. As further shown in FIG. 3, control subunit 106 may be comprised of a microcontroller (MCU) 110 which may be configured to operate via solar power generated by solar panel 111 and stored in battery 112 whereby charge controller 114 supplies the necessary 3.1V of power to the microcontroller. Coupled to MCU 110 is a communications module 116. In one aspect of the invention, communications module 116 is configured for wireless communication, such as via one or more of cellular, Long Range (LoRa), WiFi, and/or Bluetooth protocols. Communication module 116 communicates sensor data, such as that received via one or more processing chips 118 (e.g., Analog Device CN0428), to dispenser unit 104, as will be described in greater detail below. Sensor subunit 108 may include a plurality of sensors configured to monitor the water quality status of pool water 42 in real time and signal dispenser unit 104 to dispense appropriate amounts of chemical(s) to maintain a predetermined chemistry in pool 40.

By way of example and without limitation thereto, sensor subunit 108 may include skimmer unit 120 having a temperature sensor 122, a pH sensor 124 and an ORP (Oxidation-Reduction Potential) sensor 126 therein. Sensors 122, 124, 126 may interface with a BNC connector board attached to MCU 110. ORP may operate as a surrogate for measuring chlorine/bromine/other oxidizer concentration within pool water 42 while pH sensor 124 probes acidity/alkalinity of pool water 42. To improve readings, pH sensor 124 may be temperature compensated via temperature sensor 122. Additionally, a reed sensor 128 may be used to monitor pool operation and may, for example, be situated on a buoyant skimmer weir. Thus, when the skimmer weir is oriented vertically, reed sensor 128 may signal communication module 116 that pump 52 is off and pool water 42 is not being recirculated. Communication module 116 may then send a control signal to dispenser unit 104 to prevent dispenser unit from dispensing additives, as will be discussed in greater detail below.

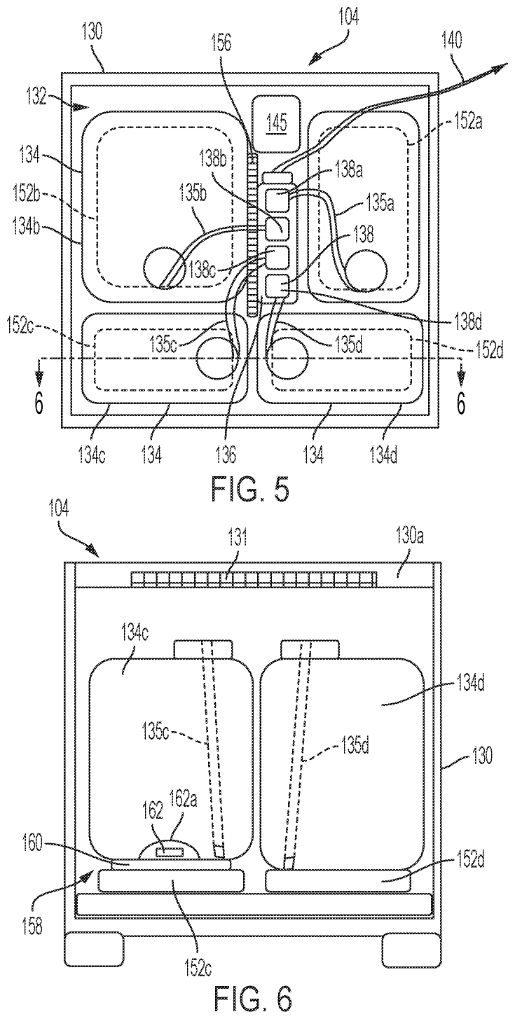

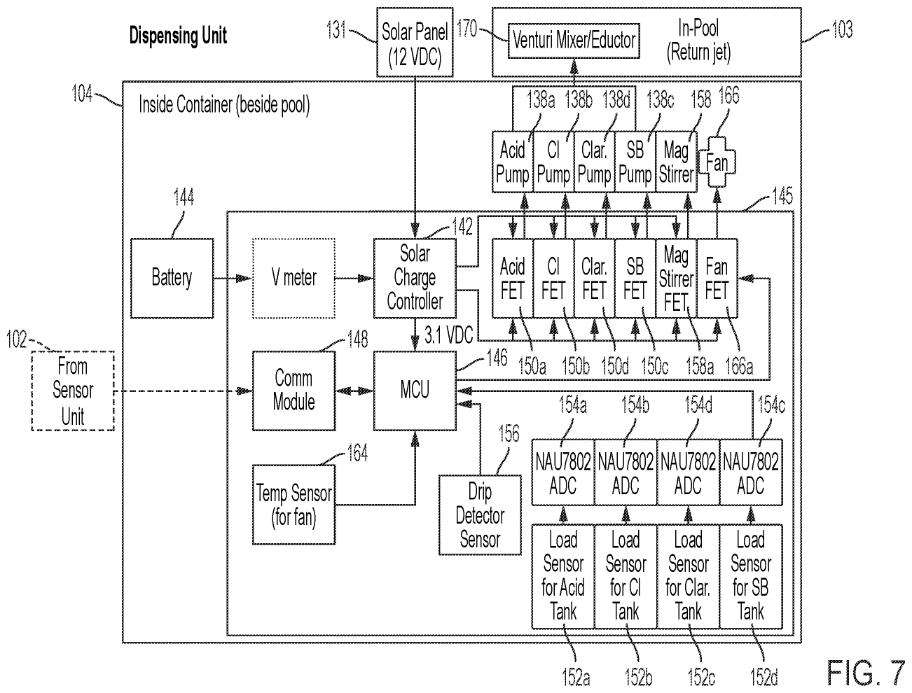

Turning now to FIGS. 4-7, an exemplary embodiment of dispenser unit 104 includes a dispenser unit housing 130 dimensioned to receive the operational components of the chemical supply subsystem 132 therein. For aesthetic purposes, dispenser unit housing 130 may be configured as a planter or cushioned seat. As shown in FIG. 5, chemical supply subsystem 132 includes a plurality of chemical containers or tanks 134. In embodiment 130 as shown, four tanks 134a-134d are provided, wherein each respective tank holds a specified material, although it should be understood that nay number or size of tanks may be used. In one configuration, the materials may include: (i) tank 134a holding muriatic acid (though sodium bisulfate can also be used) for reducing pH; (ii) tank 134b holding an oxidizer such as sodium hypochlorite, which unlike calcium based chlorines, does not contribute to cloudiness; (iii) tank 134c holding a chemical solar blanket (SB), or liquid pool solar blanket, which forms a film over the water to prevent evaporative heat and chemical loss; and (iv) tank 134d holding a clarifier.

As is known in the art, chemical SBs may comprise a mix of one more alcohols, such as isopropyl alcohol or a similar fatty alcohol, or carbinol with calcium oxide, propanediol or calcium hydroxide. One non-limiting example of a clarifier is polydiallyldimethylammonium chloride (PolyDADMAC), also commonly referred to as polyquaternium-6, which is a homopolymer of diallyldimethylammonium chloride (DADMAC). It should be noted that while an acid, oxidizer, chemical SB, and clarifier are provided, additional or alternative materials may be used depending upon the particular needs of the pool being monitored and treated. It is further envisioned that tanks 134 are made of high density polyethylene (HDPE) to be compliant with alkali, acids, and oxidizers, although any suitable container materials may be used.

With continued reference to FIG. 5, chemical supply subsystem 132 may further include a pump manifold 136 configured to house a plurality of individual pump units 138 therein, wherein each chemical tank 134 is fluidly coupled to a respective pump unit 138. By way of example and continuing the above scenario, each tank 134a-134d is separably fluidly coupled to a respective pump unit 138a-138d. While any suitable pump may be employed, in accordance with an aspect of the invention, each pump unit is a peristaltic pump. The outputs for each pump unit 138 may be combined into a common chemical delivery tube 140 for eventual delivery to pool 40, as will be described in greater detail below. A respective flow meter, not shown, may be placed inline between each tank 134 and its respective pump unit 138 to monitor and/or record the flow volumes from each individual tank stream. Further, to reduce the complexity of plumbing and fittings, and to remove a source of chemical leaks, each delivery tube 135a-135d may include a PTFE tube sinking weight to place the inlet orifice of each respective delivery tube 135a-135d at the bottom of its respective tank 134a-134d. Additionally, each delivery tube 135a-135d may enter its respective tank 134a-134d through the top of the tank.

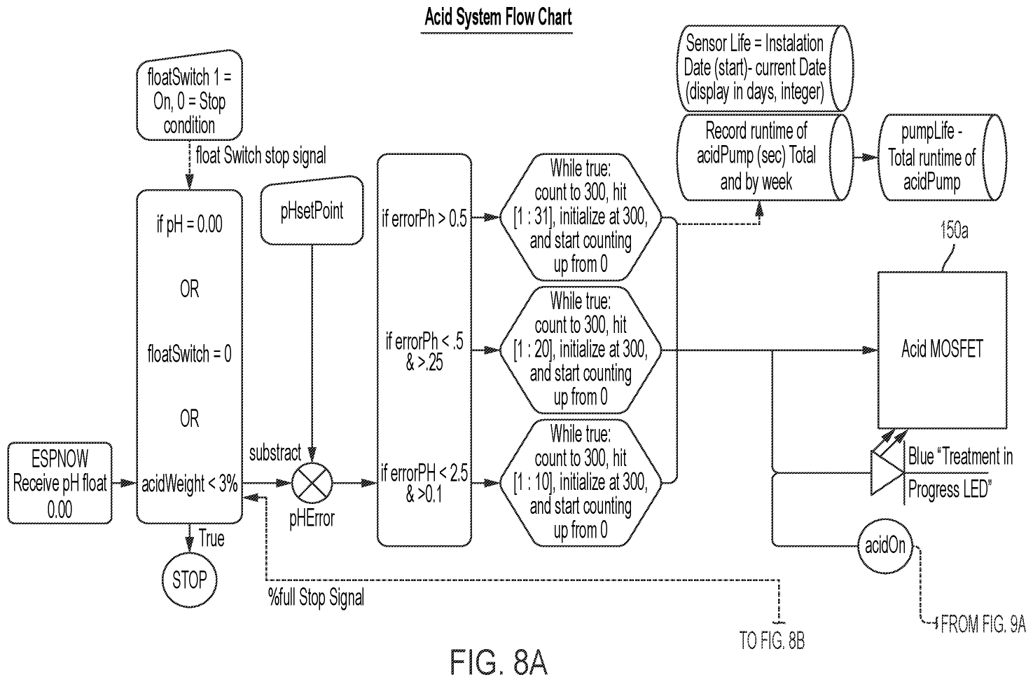

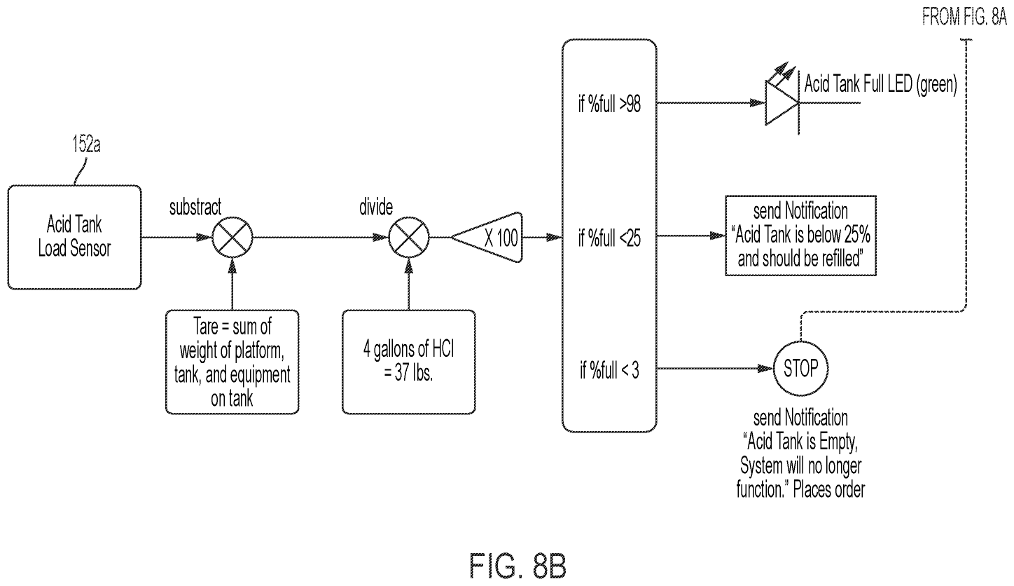

Chemical supply subsystem 132 may be powered through solar power generated by solar panel 131 which may reside on top panel 130a of dispenser unit housing 130 (see FIGS. 4 and 6). Further included within chemical supply subsystem 132, and as shown schematically in FIG. 7, is a charge controller 142 and battery 144. In one aspect of the invention, solar panel 131 may be a 10 to 20 watt panel and battery 144 may be a rechargeable 12 volt battery. A system control panel 145 including a programmable logic circuit (PLC) or microcontroller unit 146 (generally referred to herein as MCU 146) is powered by battery 144 and is configured to couple with communication module 148 for wireless connectivity with communications module 116 of sensor unit 102. MCU 146 may then exercise operative control over pump units 138a-138d, such as via a respective relay or transistor, e.g., MOSFETs 150a-150d to dispense the appropriate chemical to pool 40.

With reference to FIGS. 6 and 7, chemical supply may be automatically monitored by chemical supply subsystem 132 via a respective weigh/load sensor 152a-152d and accompanying respective Analog to Digital Converter (ADC) 154a-154d linked to MCU 146. Each load sensor 152a-152d may determine the amount of chemical in its corresponding tank 134a-134b by weighing the respective tank and calculating the remaining volume of chemical in that tank. As will be described in greater detail below, once a load sensor 134 calculates a volume less than a preset value, such as but not limited to 25%, MCU 146 may automatically communicate via communication module 148 with a web-based pool supply retailer, such as Applicant's proprietary website or an online retailer, to place an order for a tank replacement.

Additionally, in configurations where SB chemicals are used, chemical supply subsystem 132 may include an agitation system, such as but limited to a magnetic stirring mechanism 158, although other mechanisms may be used, including air- or motor-driven mixing blades or planes, pumps, or other recirculators. As discussed above, SB chemicals may include an immiscible mixture of an alcohol and calcium hydroxide (Ca(OH)₂). Thus, before introduction to pool 40, the SB chemicals must be thoroughly agitated to create a colloidal suspension. As shown in FIG. 6, an exemplary magnetic stirring mechanism 158 generally includes a stir plate 160 and stir bar 162. Stir plate 160 may be placed upon load sensor 152c and immediately beneath SB tank 134c, while stir bar 162 is placed within SB tank 134c. Powering of stir plate 160 (such as via switching on FET 158a under operational control of MCU 146) induces stir bar 162 to spin, wherein such spinning causes stirring/mixing of the liquid within tank 134c. Sufficient stirring creates the necessary colloidal suspension for introduction of the SB chemicals to pool 40.

As is known in the art, powering of stir plate 160 with too high of a spin rate may cause stir bar 162 to operationally decouple from stir plate 160, thereby causing stir bar 162 to move erratically across stir plate 160 so as not form the necessary vortex for mixing. To prevent this unwanted decoupling of magnetic stir bar 162 from stir plate 160, a stir bar securement 162a may be included. Two possible nonlimiting examples include a stir bar securement 162a that has a cage-like dome secured over stir bar 162 along the bottom surface of SB tank 134c, or may include a ring that attaches the stir bar 162 to the bottom surface of SB tank 134c to tether stir bar 162 to the SB tank 134c.

With continued reference to FIG. 6, chemical supply subsystem 132 may further include a drip sensor 156. In one non-limiting embodiment, drip sensor 156 may comprise a circuit board with ladder-like metal contacts that make electrical contact when water drips onto the board. Drip sensor 156 may be placed directly under the pumps such that any electrical contact may indicate a chemical leak which will then send a communication signal to MCU 146 to stop operation of chemical supply subsystem 132, and may also issue a text or SMS message or a push notification to the pool owner/operator. Chemical supply subsystem 132 may also include a temperature sensor 164 within housing 130 and a fan 166 under operational control of MCU 146, such as via switching of FET 166a, whereby fan 166 may circulate air within housing 130 so as to prevent overheating of the components of chemical supply subsystem 132.

In one configuration, chemical introduction unit 103 introduces a venturi-based device 170 into return line 62 of existing pool filtration system 50. As is known in the art a venturi-based device, such as but not limited to an eductor, venturi nozzle, or venturi injector is a solid-state liquid-liquid mixer. As used herein the term “venturi” shall incorporate any device that operates using the venturi effect unless a specific device is expressly stated or is dictated by context. In accordance with an aspect of the present invention, a venturi 170 may be placed in return line 62 immediately downstream of the last-most piece of pool equipment (e.g., filter 54 or heater 56, if used), or alternatively and more preferably, the venturi 170 may be placed at or in pool 40 through fluid connection with jet/outlet 64 of pool filtration system 50. In either configuration, at least a portion of the flow of filtered water 42b in return line 62 is passed through venturi 170.

As shown schematically in FIG. 2A, venturi 170 may include, along the flow of the water from upstream 171a to downstream 171b, cylindrical inlet 172, conical convergent portion 174, cylindrical throat 176, and conical divergent outlet 178. In throat 176, the flow velocity of the water is maximum while the pressure is minimum, thereby creating a negative pressure differential (vacuum) within throat 176. Throat 176 may then include port 180 which is configured to connect to chemical delivery tube 140. Thus, the chemicals may be drawn from the dispenser unit 104 and pass through chemical delivery tube 140 to venturi 170 where the chemicals are introduced to, and mixed with, the passing pool water (i.e., filtered water 42b) for introduction into the pool 40. The negative pressure generated by the venturi mixes the introduced chemicals with the pool water to reduce localized chemical concentrations, and thereby reduce user discomfort. That is, the venturi/eductor reduces chemical gradients within the water returned to the pool, and hence within the pool.

In one exemplary embodiment of the present disclosure, water treatment apparatus 100 does not require a separate, dedicated intake into the pool, but rather may be directly fluidly connected to an existing return line 62 of pool filtration system 50 by coupling cylindrical inlet 172 to (or in place of) the already existing return line jet 64 inside pool 40. In another non-limiting configuration, NPT (National Pipe Taper) fittings may be used to connect the output of venturi 170 to the existing return line, or a split of the existing return line, such that the output of the venturi is fluidly coupled to the pool.

As described above, in one non-limiting configuration, it is contemplated that venturi 170 is located within pool 40. Dispenser unit 104 may thus sit poolside, as opposed to being remotely located within a pool pump room. Peristaltic pumps 138, under the control of MCU 146, may then pump the additives (e.g., one or more of the chemicals in tanks 134) into common chemical delivery tube 140, such as a PVC conduit, that connects to the chemical feed inlet (port 180, which may be perpendicular to the direction of water flow) at the throat 176 of venturi 170. It is understood that the entire flow 42b of the existing return line 62 can pass though venturi 170, or that only a portion 42b′ of the flow in the return line 62 passes through venturi 170.

Without being tied to any particular theory, it is contemplated that the use of venturi 170 allows the present chemical supply subsystem 132 to utilize relatively low power peristaltic pumps to add chemicals to the venturi inlet 172. In contrast, existing pool sanitation systems must utilize higher power pumps as these pumps must overcome the inline pressure of the pool recirculation system. That is, the present system provides for the introduction of chemicals without having to fully overcome the existing inline pressure of the pool recirculation system. As the venturi generates a negative pressure within the throat for the chemicals to be added, the present system has a much lower power requirement to introduce the chemicals in the pool recirculation system.

In one exemplary operation of water treatment apparatus 100, disbursement of the acid and oxidizer may be based on sensor input, e.g., sensed data from pH sensor 124 and ORP sensor 126, respectively, while the solar blanket (SB) and the clarifier may be added at a set time interval, or on a set schedule, such as but not limited to once or twice a week. In one aspect, the SB can be dispensed either based on a timer or based on the ambient temperature, such that dispensing of SB from tank 134c may be upregulated when the ambient (atmospheric) temperature drops below a specified threshold, such as 70° F. Further, it is contemplated as the acid and the oxidizer are introduced based on sensor input, the amount and timing are variable as a function of the relevant parameters resulting in the sensor input. In contrast, clarifier may be added in predetermined increments or volumes.

In one non-limiting configuration, the water treatment apparatus 100 may have a control strategy that only dispenses chemicals when it is dark (as detected by a photosensor/photodiode, not shown, communicatively coupled to MCU 146), and when the Reed switch is oriented in the upright position signaling that the power to the existing pool filtration system 50 is not running. It is further contemplated that as ORP directly affects Free Available Chlorine (FAC) and that the acid and oxidizer cannot be dispensed simultaneously due to the toxic gas production that would ensue, the pH of pool water 42 should be corrected prior to correcting oxidizer levels. This is accomplished by simply running pH and ORP pumps 138a, 138b at separate times and running the ORP pump 138b only after the pH has reached its setpoint as monitored by pH sensor 124. Additionally, care should also be taken to prevent simultaneous addition of ORP from tank 134b and clarifier from tank 134d due to the potential of toxic gas production due to the mixing of a (chlorine) oxidizer with an (ammonium-based) coagulant.

In accordance with a further aspect of the invention, water treatment apparatus 100 may be web-enabled to allow for automatic ordering of chemicals when the level of any chemical drops below a predetermined amount and, to interact with a computer or smartphone software application which may remotely display chemical parameters, temperature, and tank chemical levels. It is further contemplated that water treatment apparatus 100 may operate using a cartridge-based retention and dispensing regime for the additives, including the acid, oxidizer, SB, and clarifier. These cartridges may aid in preventing the user from spilling chemicals inside the unit or accidentally mixing oxidizer and acid, which could lead to the formation of toxic gas. Users may also be able purchase replacement chemical cartridges when existing cartridges are exhausted or at a predetermined level, with the cartridges including all necessary tubing and hardware. Cartridges may also each be under 25 lbs. so that consumers can comfortably lift and insert these cartridges into their dispenser unit.

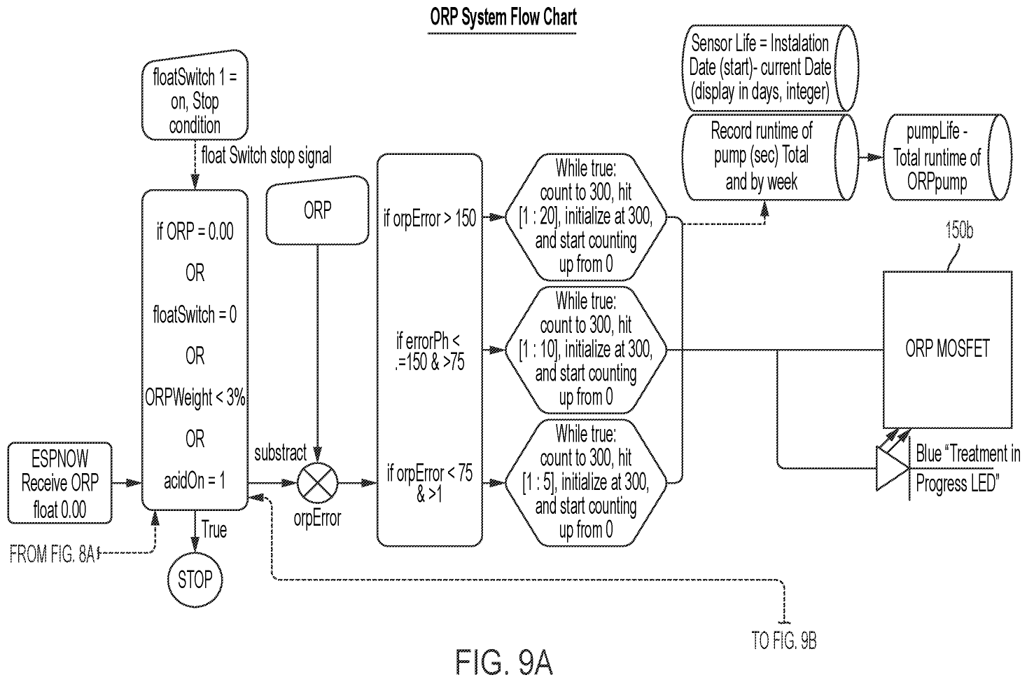

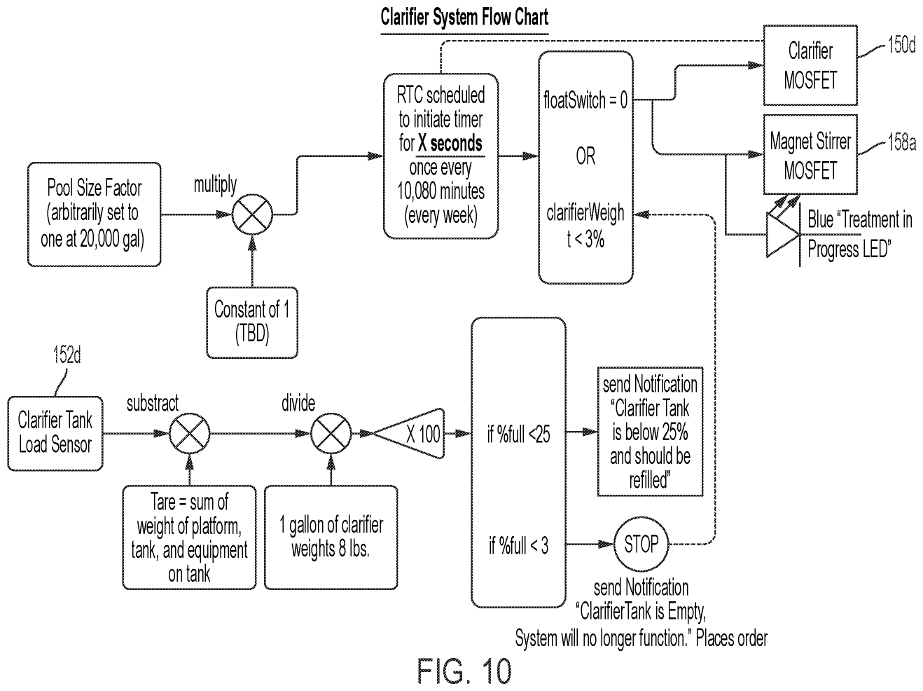

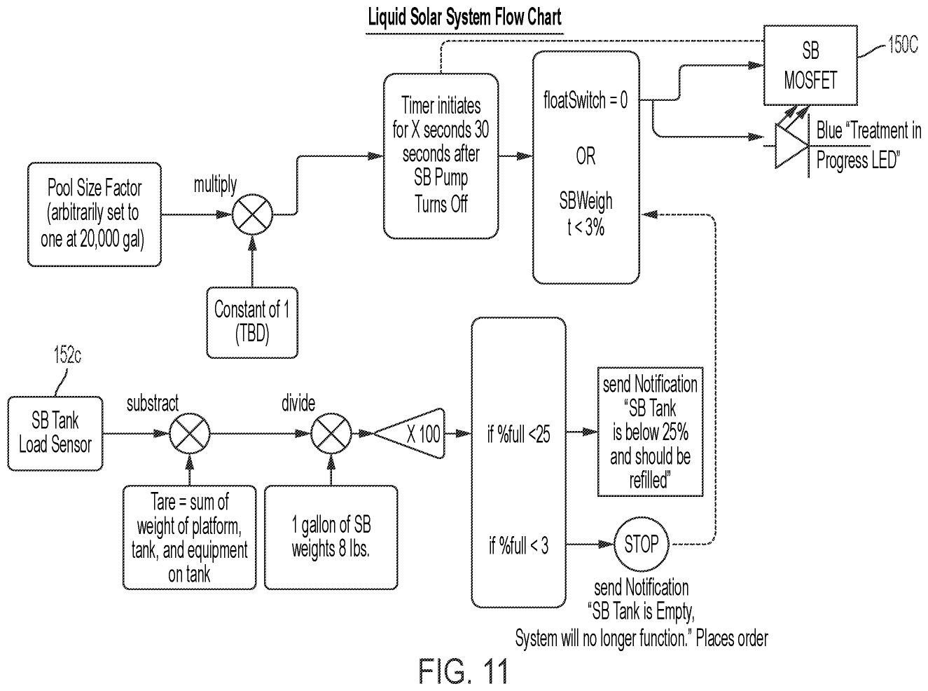

As discussed above, communications module 116 of sensor unit 102 sends wireless (e.g., LoRa) transmissions that include ORP sensor 126 data, pH sensor 124 data, temperature sensor 122 data, and reed sensor 128 status to the (e.g., LoRa) receiver of communications module 148 and dispenser unit MCU 146. As shown in FIGS. 8-11, MCU 146 may be programmed to include code executable to operate in the following manner:

System Error Stop Conditions: If there is no communication between sensor unit 102 and dispenser unit 104, or the levels of pH sensor 124 and/or ORP sensor 126 are out of a preselected range which may indicate a defective sensor, sensor unit 102 will send a stop signal to dispenser unit 104. Additionally, an upright (e.g. vertical) Reed sensor 128 or an absence of liquid chemical, which may be defined as 3% or less, in any of the four tanks 134a-134d, as detected by their respective load sensor 152a-152d, may also stop one or more pump units 138a-138d. By way of example and without limitation, a lack of clarifier and/or solar blanket (SB) will shut down whichever pump unit(s) 138c, 138d that is/are serviced by the empty clarifier and/or SB tank 134c, 134d. However, the absence of acid (tank 134a) or sanitizer (tank 134b) will trigger MCU 146 to send a stop signal to dispenser unit 104 to shut off the entire pump manifold 136. Communication module 148 of dispenser unit 104 may also alert the pool owner (or a third-party contractor) by text or SMS message or push notification via the system's software application.

Furthermore, if either of the sensor or dispenser units 102, 104 overheats as measured by their respective humidity and temperature sensors (if equipped), the respective unit 102, 104 will stop until it cools down. Furthermore, pool owner (or a third-party contractor) may also remotely stop operation of the dispenser unit 104 by communicating with MCU 146 over the wireless network.

pH and ORP Conditions: pH sensor 124 data is temperature compensated via temperature sensor 122 and via system firmware (e.g., sensor chip 118a). This compensation value is then subtracted from a pH setpoint to calculate the pH error. ORP sensor 126 data is also compensation-corrected from the setpoint to calculate the ORP error. MCU 146 activates pH MOSFET 150a and/or ORP MOSFET 150b to dispense chemicals for specified periods of time, with specified interluding periods. The dispensing regime is based on the magnitude of the error, with smaller errors awarded shorter pump periods when compared to higher error values in order to produce a proportional controlled system.

Clarifier and SB Conditions: The clarifier and the SB subsystems (e.g., tank 134c/pump unit 138c; and tank 134d/pump unit 138d) are not sensor-actuated, but may be triggered by one or more of a timer, weather conditions, and/or directly by the pool owner/third-party contractor. As pools can get cloudy after it rains, interfacing MCU 146 with a cellular or WiFi network may allow dispenser unit 104 to ping local weather data to assess weather conditions, wherein the weather data may initiate MCU 146 to adjust the timing of clarifier dispersal. It is also contemplated that MCU 146 may be responsive to ambient weather conditions to ping local weather stations and upregulate SB dispersal when the atmospheric temperature is colder than a preset limit in order to maintain a high water temperature within pool 40.

Turning now to FIGS. 8A and 8B, electrically, pump unit 138a in the acid subsystem (hereinafter defined as comprising tank 134a and pump unit 138a) connects to MOSFET one (e.g., FET 150a, FIG. 7) of the system, which is controlled by code stored within MCU 146, such as via C++ programming. An exemplary C++ program may be configured to dispense acid when certain conditions are met and when there is an adequate supply of acid in acid tank 134a.

As seen in FIGS. 8A and 8B, there are several layers of logic to the acid subsystem. For conditions that may cause dispenser unit 104 to shut off, MCU 146 interrogates sensor data to determine if load sensor 152a (e.g., the tank chemical level sensor) or pH sensor 124 data is missing or defective (as communicated via sensor unit 102 communications module 116). A defective sensor 152a or 124 will signal MCU 146 to prevent activation of acid pump unit 138a (e.g., MOSFET 1 (FET 150a)) or cause pump unit 138a to turn off. A defective pH sensor 124 may have a pH that is below or above a respective threshold and thus out of range for a pool, while a defective weigh/load sensor 152a may have a weight that is out of range for tank 134a.

If the sensor is not defective, the MCU 146 will determine if the pH measured by pH sensor 124 is above a setpoint, which, in one nonlimiting example, may be selected to be pH 7.4. If the pH is greater than the setpoint by more than 0.2 pH units, the signal to dispense acid will pass to the next level of logic, that is the weigh/load sensor 152a. If weigh/load sensor 152a is not defective and does not detect an “empty” tank 134a, MCU 146 will activate an acid trigger signal to clear the control switch, where MCU 146 then begins a 30 second countdown to trigger FET 150a to turn on acid pump unit 138a. A dead band may be used to reduce chatter/rapid on-off succession of MOSFET 1. Chatter, (the rapid on/off succession of a pump under sensory control and caused by a signal that straddles the threshold and vacillates above and below it), is reduced by ensuring that the system only responds to appropriate triggering events.

If the trigger signal is “1” for more than 30 seconds, or at least a predetermined time that reduces chatter, MCU 146 will activate MOSFET 1 (FET 150a). Activating MOSFET 1 (FET 150a) causes pump unit 138a to dispense acid into the pool at a low flow rate, such as 100 ml/min, via venturi 170, as described above. While any suitable flow rate may be used, a low flow rate, such as 100 ml/min, may be selected so as to reduce or prevent overshooting the target level of chemical (e.g., muriatic acid) introduced to pool 40. In accordance with an aspect of the present invention, the introduction flow rate of the chemical may be a function of venturi flow, pool size, and chemical concentration, and is selected to avoid overshooting the target level of chemical in the pool.

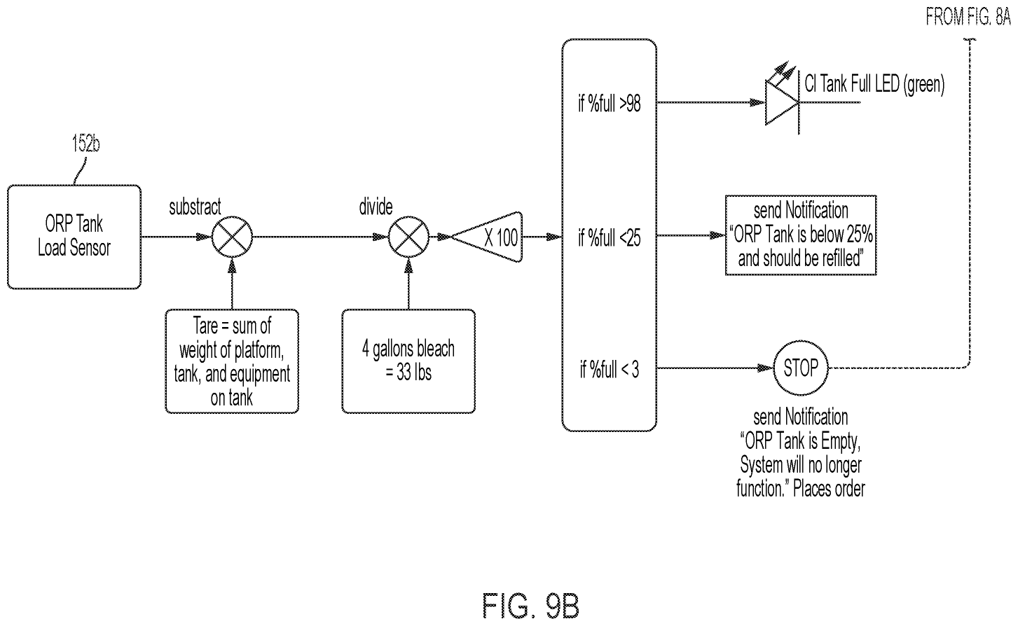

As seen in FIGS. 9A and 9B, ORP subsystem (hereinafter defined as comprising tank 134b and pump unit 138b) operates similarly to the acid subsystem discussed above with regard to FIGS. 8A and 8B. MCU 146 is programmed to execute similar logic as that used in conjunction with the acid subsystem in that MCU 146 includes: ORP subsystem tests for defective ORP sensor 126 and ORP load sensor 152b; an ORP subsystem setpoint that triggers MCU 146 to initiate a dispensing signal; and a level switch that prevents dispensing ORP chemicals from tank 134b if ORP load sensor 152b measures that tank 134b is empty. MCU 146 may also be programmed to include a dead band for ORP sensor 126 to prevent chatter. One non-limiting example may have a dead band set to +/−50 of a threshold value of 650 mV. If ORP sensor 136 detects an ORP level that is out of the preselected range and ORP load sensor 152b indicates that tank 134b is not empty, MCU 146 will then initiate an ORP trigger signal to activate MOSFET 2 (FET 150b, FIG. 7) to turn on ORP pump unit 138b to dispense ORP chemicals into pool 40 via venturi 170, as described above.

It should also be noted that a PID (proportional-integral-derivative) controller may also be included with either or both of the acid and/or ORP subsystems to reduce the likelihood that the subsystem will overshoot the programmed target value.

Unlike the acid and ORP subsystems, clarifier subsystem (hereinafter defined as comprising tank 134d and pump unit 138d) is not actuated by a sensor but is actuated based upon a preselected time interval, such as measured by an internal clock on MCU 146. By way of example and without limitation, the clock may count down a preselected period of time, such as for example, one week) wherein expiration of the clock interval causes MCU to initiate a triggering signal to activate MOSFET 3 (FET 150d, FIG. 7) if clarifier tank 134d is not empty as measured by load sensor 152d. In a further aspect of the invention, if MCU 146 and communications module 148 have been integrated with the internet and programmed to include a web-based application, MCU 146 may programmed or be remotely activatable so as to adjust the frequency of clarifier dispensing according to the weather, such as increasing dispensing after rainstorms which can introduce particulate matter into the pool and cause cloudiness.

The SB subsystem (hereinafter defined as comprising tank 134c and pump unit 138c) is similar to the clarifier subsystem with SB chemical dispensing being timer based. SB dispensing may also be adjustable depending upon weather data, such as being upregulated to guard against heat loss caused by cold weather. As the SB additive reduces evaporative chemical, water, and heat losses, dispensing the additive could be tied to atmospheric temperature and thus upregulated in order to maintain a comfortable water temperature, should the ambient temperature drop. Alternatively, the additive is also protective against chemical and water evaporation during hot weather and its dispensing could also be upregulated to guard against these losses during hot weather.

In a further aspect of the present invention, when any chemical volume is low (as detected by any load sensor 152a-152d), MCU 146 may interface with a third-party company server, which may process the data so as to aid in data aggregation, visualization, and analysis of live data streams in the cloud. Data can be sent to a third-party company server, wherein instant visualization of live data can be generated and alerts can be sent by the server to the pool owner, such as via text or email, or to a designated web-based application. The third-party company server may also automatically send reorder instructions for any necessary chemicals for delivery to the pool owner. The chemicals may arrive to the pool owner in prefilled and plumbed tanks 134 for case in replacement and used tank recycling.

Returning to FIGS. 2 and 2A, in an alternative embodiment, chemical introduction unit 103′ (e.g., venturi 170′) may be placed within a venturi-style skimmer unit 190 which is plumbed to jet/outlet 64b of pool filtration system 50 (such as via skimmer tube 192) so as to reside within pool 40 below the water level of pool water 42. High pressure filtered water 42b is injected into venturi 170′ and passes through skimmer unit body 194 and out of skimmer outlet 196. Thus, the chemicals may be drawn from the dispenser unit 104 and pass through chemical delivery tube 140 to venturi 170′ where the chemicals are introduced to, and mixed with, the passing pool water (i.e., filtered water 42b) for introduction into the pool 40. The negative pressure generated by the venturi mixes the introduced chemicals with the pool water to reduce localized chemical concentrations, and thereby reduce user discomfort. That is, the venturi/eductor reduces chemical gradients within the water returned to the pool, and hence within the pool.

Moreover, skimmer unit 190 includes a floating hat 198 nested within skimmer unit body 194. The floating hat 198 includes a barrel portion having a terminal edge 200 wherein the barrel portion is configured to translate vertically within skimmer unit body 194 such that terminal edge 200 remains positioned along the top of the water level of pool water 42. Venturi 170′ may also generate a downward flow within skimmer unit body 194 which, in turn, causes pool water 42 to flow over terminal edge 200, through the barrel portion and into skimmer unit body 194. Materials floating on the pool surface may then be passed into skimmer unit body 194 where they may be captured within a container (such as a replaceable netted bag 202) coupled to skimmer outlet 196.

Floating hat 198 may also include a motion detector 204 mounted thereon. Motion detector 204 may be in wireless communication with communications module 148 and MCU 146. When pool 40 is not in active use, motion detector 204 may be programmed to issue an alert should floating hat 198 undergo rapid vertical translation greater than a predetermined threshold. The predetermined threshold may be selected so as to indicate a person or object falling into the pool. Communications module 148 and MCU 146 may then communicate to the pool owner/operator, such as via a text or SMS message or a push notification, that someone or something has entered the pool. This may signal unauthorized use or indicate an emergency such as a toddler or pet accidentally falling into the pool.

In view of the above, the present system offers significant advantages over the current art. Generally, the present disclosure provides a poolside, self-powered, plug-and-play, complete system that injects additives into the pool return line and orders depleted reagents and has features that include:
(i) operates directly with the existing return line of the pool system by attaching the dispenser venturi to the return jet;
(ii) is installation-free requiring only attaching the dispenser venturi to the return jet and placing the sensor box in the pool intake (skimmer). Alternative systems require replumbing of the pool water lines as well as hard wiring of the system by an electrician;
(iii) provides automated ordering chemicals based on precisely monitored chemical additive levels through contactless monitoring of the weight of the respective chemical reservoirs/tanks;
(iv) includes a control strategy that employs weather data for dispensing of chemicals;
(v) provides a turbidity of under 0.1 NTU with continuous water quality within predetermined acceptable limits or thresholds;
(vi) features a PID (proportional-integral-derivative) controller that employs both weather data and user input to optimize chemical dispensing; and
(vii) includes a venturi allowing for the use of relatively low-powered pumps which provides a significant cost and energy benefit over the existing high-powered pumps currently used for water treatment systems.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A water treatment apparatus for a pool system, the pool system including a pool wall configured to retain pool water therein, a circulating pump having an intake and an outlet, an intake line connecting the pool to the intake, and a return line connecting the outlet to a return jet at the pool, the treatment apparatus comprising:
(a) a chemical introduction unit having a first end configured to be coupled to the return jet and a second end configured to be in fluid communication with the pool water, wherein the chemical introduction unit is configured to selectively dispense a controlled quantity of an additive to the pool water;
(b) a dispensing unit comprising:
(i) a first chemical reservoir connected to the chemical introduction unit through a first line, the first chemical reservoir configured to retain a first chemical therein; and
(ii) a second chemical reservoir connected to the chemical introduction unit through a second line, the second chemical reservoir configured to retain a second chemical therein;
(c) a sensor unit including:
(i) a pH sensor configured to be received within the pool to sense a pH value of the pool water;
(ii) an oxidation-reduction potential (ORP) sensor configured to be received within the pool to sense an ORP of the pool water; and
(iii) a first communications module configured to be coupled to the pool wall outside of the pool water, wherein the first communications module is communicatively coupled to the pH sensor and the ORP sensor; and
(d) a controller including:
(i) a control unit operably connected to the dispensing unit; and
(ii) a second communications module communicatively coupled to the first communications module of the sensor unit to receive sensed pH data and sensed ORP data of the pool water,
wherein the controller is configured to regulate:
(i) an amount of the first chemical dispensed from the first chemical reservoir and passing through the chemical introduction unit, wherein the amount of the first chemical dispensed is based at least in part on the sensed pH of the pool water; and
(ii) an amount of the second chemical dispensed from the second chemical reservoir and passing through the chemical introduction unit, wherein the amount of the second chemical dispensed is based at least in part on the sensed ORP of the pool water.

2. The treatment apparatus of claim 1, wherein the dispensing unit further comprises a first level sensor configured to sense a fluid level of the first chemical in the first chemical reservoir and a second level sensor configured to sense a fluid level of the second chemical in the second chemical reservoir.

3. The treatment apparatus of claim 2, wherein the first level sensor and the second level sensor are each communicatively coupled to the second communications module, wherein when the sensed fluid level of the first chemical and/or the sensed fluid level of the second chemical is below a respective preselected threshold, the second communications module is configured to automatically order additional at least one of the first chemical and the second chemical based upon which sensed fluid level is below its respective preselected threshold.

4. The treatment apparatus of claim 1, wherein each of the first communications module and the second communications module is at least one of Wi-Fi enabled, Bluetooth enabled, cellular network enabled, and Long Range (LoRa) enabled.

5. The treatment apparatus of claim 4, wherein the second communications module is configured to receive weather data local to the pool.

6. The treatment apparatus of claim 1, wherein the pool is one of a swimming pool, a spa pool, a swim spa, a wading pool, and a spray pool.

7. The treatment apparatus of claim 1, wherein the chemical introduction unit includes a venturi having an inlet configured to be coupled to the return jet to receive pool water from the return line and an outlet configured to be in fluid communication with the pool water within the pool, wherein the venturi further includes a throat located between the inlet and outlet, wherein the throat has a smaller open interior diameter than an open interior diameter of the inlet and an open interior diameter of the outlet, and wherein the venturi further includes a port having a first end in fluid communication with the throat and a second end configured to be fluidly coupled to dispensing unit to inject one or both of the first chemical and the second chemical into the pool water.

8. The treatment apparatus of claim 7, wherein the venturi is an eductor.

9. The treatment apparatus of claim 1, wherein the dispensing unit includes a first flow meter fluidly coupled to the first chemical reservoir and a second flow meter fluidly coupled to the second chemical reservoir.

10. The treatment apparatus of claim 1, wherein the dispensing unit includes a first peristaltic pump fluidly coupled to the first chemical reservoir and a second peristaltic pump fluidly coupled to the second chemical reservoir.

11. The treatment apparatus of claim 1, further comprising a photosensor coupled to the controller, wherein the dispensing unit is only turned on during the night.

12. The treatment apparatus of claim 1, further comprising a rechargeable battery, a solar panel, and a charge controller.

13. The treatment apparatus of claim 1, wherein the dispensing unit further comprises a third chemical reservoir connected to the chemical introduction unit through a third line, the third chemical reservoir configured to retain a third chemical therein; and wherein the controller is configured to regulate an amount of the third chemical dispensed from the third chemical reservoir and passing through the chemical introduction unit.

14. The treatment system of claim 13, wherein the dispensing unit further comprises a third level sensor configured to sense a level of the third chemical in the third chemical reservoir, wherein the third level sensor is communicatively coupled to the second communications module, wherein when the sensed fluid level of the third chemical is below a preselected threshold, the second communications module is configured to automatically order additional third chemical.

15. The treatment apparatus of claim 13, wherein the second communications module is configured to receive weather data local to the pool, and wherein the controller is configured such that the third chemical is dispensed as a function of one of an elapsed time and received weather data.

16. The treatment apparatus of claim 13, wherein the dispensing unit further comprises a fourth chemical reservoir connected to the chemical introduction unit through a fourth line, the fourth chemical reservoir configured to retain a fourth chemical therein; and wherein the controller is configured to regulate an amount of the fourth chemical dispensed from the fourth chemical reservoir and passing through the chemical introduction unit.

17. The treatment system of claim 16, wherein the dispensing unit further comprises a third level sensor configured to sense a fluid level of the third chemical in the third chemical reservoir and a fourth level sensor configured to sense a fluid level of the fourth chemical in the fourth chemical reservoir, wherein the third level sensor and the fourth level sensor are each communicatively coupled to the second communications module, wherein when the sensed fluid level of the third chemical and/or the sensed fluid level of the fourth chemical is below a respective preselected threshold, the second communications module is configured to automatically order additional at least one of the third chemical and the fourth chemical based upon which sensed fluid level is below its respective preselected threshold.

18. The treatment apparatus of claim 16, wherein the second communications module is configured to receive weather data local to the pool, and wherein the controller is configured such that one or both of a first predetermined volume of the third chemical and a second predetermined volume of the fourth chemical are introduced as a function of one of at least one of an elapsed time and received weather data.

19. The treatment apparatus of claim 16, wherein the dispensing unit further comprises an agitator coupled to the fourth chemical reservoir wherein the agitator is configured to stir the fourth chemical prior to dispensing the fourth chemical to the chemical introduction unit.

20. The treatment apparatus of claim 19, wherein the agitator comprises a magnetic stir plate positioned below the fourth chemical reservoir and a magnetic stir bar contained within the fourth chemical reservoir, wherein powering of the magnetic stir plate causes the magnetic stir bar to spin.

21. The treatment apparatus of claim 20, wherein the fourth chemical reservoir includes a magnetic stir bar securement to prevent decoupling of the magnetic stir bar from the magnetic stir plate.

22. A method for treating water within a pool system, the pool system including a pool wall configured to retain pool water therein, a circulating pump having an intake and an outlet, an intake line connecting the pool to the intake, and a return line connecting the outlet to a return jet at the pool, wherein the method comprises:
(a) providing a water treatment apparatus including: a chemical introduction unit having a first end configured to be coupled to the return jet and a second end configured to be in fluid communication with the pool water; a dispensing unit having a first chemical reservoir connected to the chemical introduction unit through a first line and a second chemical reservoir connected to the chemical introduction unit through a second line; a sensor unit including a pH sensor, an oxidation-reduction potential (ORP) sensor, and a first communications module; and a controller including a control unit and second communications module communicatively coupled to the first communications module of the sensor unit;
(b) sensing, via the pH sensor, a pH value of the pool water;
(c) sensing, via the ORP sensor, an ORP of the pool water;
(d) receiving at the second communications module via the first communications module, the sensed pH data and the sensed ORP data of the pool water;
(e) regulating, via the controller, an amount of the first chemical dispensed from the first chemical reservoir and passing through the chemical introduction unit, wherein the amount of the first chemical dispensed is based at least in part on the sensed pH of the pool water; and
(f) regulating, via the controller, an amount of the second chemical dispensed from the second chemical reservoir and passing through the chemical introduction unit, wherein the amount of the second chemical dispensed is based at least in part on the sensed ORP of the pool water.
